(19) United States
(12) Patent Application Publication
(10) Pub. No.: US 2008/0284393 A1
(43) Pub. Date: Nov. 20, 2008

(54) Reduced Noise Low Drop Output Arrangement

(75) Inventors: Georgi Panov, Munich (DE); Ettore Riccio, Ottobrunn (DE)

Correspondence Address: LEE & HAYES, PLLC, 421 W RIVERSIDE, SUITE 500, SPOKANE, WA, 99201, US

(73) Assignee: INFINEON TECHNOLOGIES AG, Neubiberg (DE)

(21) Appl. No.: 11/748,423

(22) Filed: May 14, 2007

(51) Int. Cl. G05F 1/56

(52) U.S. Cl. 323/280

(57) ABSTRACT

Implementations related to low drop output (LDO) circuit arrangements are presented herein.

### BACKGROUND

Various low voltage applications require the use of low drop output (LDO) circuit arrangements. Such applications may include wireless devices, paging devices, and computers. Generally, an LDO circuit supplies a highly regulated voltage to components of a system, where the source of the regulated voltage may be generated from a direct power source (e.g., a battery).

An output of an LDO circuit arrangement generally requires a large capacitive load to limit voltage fluctuations. The large capacitive load can also help stabilize the LDO circuit arrangement. However, the large capacitive load, generally a capacitor, necessarily increases the size of a device implementing the LDO. The board area occupied by the capacitor normally manifests this size increase.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 is a block diagram illustrating a plurality of stages associated with a low drop output (LDO) circuit arrangement according to at least one exemplary implementation. A low impedance section is used to help minimize the size of a stabilizing capacitor that may be implemented at an output of the LDO circuit arrangement.

FIG. 2 illustrates a schematic circuit diagram of an LDO circuit arrangement employing a low impedance section to improve stability when good noise performance is desirable. The low impedance section, implemented in this illustration with a resistor, enables use of a substantially small capacitor in an output stage of the LDO circuit arrangement.

FIG. 3 illustrates a schematic circuit diagram of an LDO circuit arrangement employing a low impedance section to improve stability when good noise performance is desirable. The low impedance section, implemented in this illustration with a resistor and a biasing source, enables use of a substantially small capacitor in an output stage of the LDO circuit arrangement.

FIG. 4 illustrates a detailed schematic circuit diagram of an LDO circuit arrangement employing a low impedance section to improve stability when good noise performance is desirable. The low impedance section, implemented in this illustration with a resistor and a biasing source, enables use of a substantially small capacitor in an output stage of the LDO circuit arrangement.

### DETAILED DESCRIPTION

### Overview

At least one or more implementations described herein relate to low drop output (LDO) circuit arrangements that provide low noise performance, good stability and a substantially constant output voltage. At least one of the LDO circuit arrangements described herein achieves these performance results even though an output stage thereof employs a substantially small capacitor. Use of a substantially small capacitor is achieved by coupling a low impedance path to an LDO circuit arrangement. In one implementation, the low impedance path is coupled to an output of an amplifier stage associated with an LDO circuit arrangement. The LDO circuit may employ a multistage amplifier arrangement. In one implementation, the low impedance path includes a poly-resistor. In another implementation, the low impedance path includes a resistor coupled to a biasing source. To achieve the resistance of the low impedance path, a single resistor may be used, or a plurality of resistors may be used to achieve a desired resistive value.

### Exemplary Arrangements

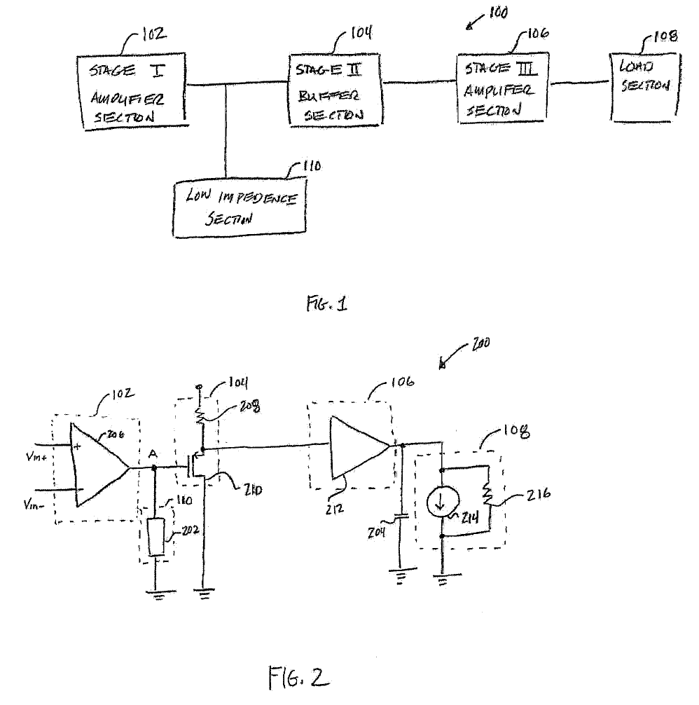

FIG. 1 illustrates a block diagram including a plurality of stages associated with a low drop output (LDO) circuit arrangement 100 according to at least one exemplary implementation. A low impedance section 110 is used to help minimize the size of a stabilizing capacitor that may be implemented at an output of the LDO circuit arrangement.

The LDO circuit arrangement 100 may include a stage I amplifier section 102. Although not shown in FIG. 1, the stage I amplifier section 102 may receive a voltage from a voltage source. The voltage source may be a battery, or another voltage supplying source. A stage II buffer section 104 is connected to the stage I amplifier section 102. The stage II buffer section 104 receives a voltage from the amplifier section 102 and then generates a buffered voltage.

A stage III amplifier section 106 is coupled to the buffer section 104 and receives the buffered voltage from the buffer section 104. The stage III amplifier section 106 generates a predetermined and substantially constant output voltage. This voltage is supplied to a load section 108. The supplied voltage should be sufficient to drive the load section 108. The load section 108 may be a voltage control oscillator (VCO). The load section may also be other circuitry related to modems, set-top boxes, and various battery-operated devices.

The low impedance section 110 is coupled to an output of the stage I amplifier section 102 and an input of the stage II buffer section 104. The low impedance section 110, including an unbiased or biased resistance, may be used to help stabilize the LDO circuit 100. The low impedance section 110 is capable of stabilizing the LDO circuit 100 even when a small capacitor is coupled to the stage II amplifier section 106 and the load section 108.

A large capacitor, frequently referred to as a bypass capacitor, is often used to stabilize the output voltage of conventional LDO circuits. Instability in the output voltage may be caused by current spikes associated with a load connected to the LDO circuit. The large capacitor may be used to add a dominate pole at a final stage of an LDO circuit. Without the large capacitor, an LDO may become unstable as a load current increases. This is because the stability of an LDO is generally related to the ratio between the load current and the bypass capacitor.

In distinction, the embodiments described herein ensure the presence of a dominate pole, and therefore a stable system, at the output of an LDO circuit without the use of a large capacitor. The implementations described herein at least partially rely upon the low impedance section 110 for stability. Minimizing the size of such a stabilizing capacitor may significantly reduce costs associated with manufacturing LDO circuits, increase reliability and reduce power consumption.

FIG. 2 illustrates a schematic circuit diagram of an LDO circuit arrangement 200 according to at least one exemplary implementation. The low impedance section 110, implemented in this illustration with a resistor 202, enables use of a substantially small capacitor 204 in an output stage of the LDO circuit arrangement 200.

In the implementation illustrated in FIG. 2, the stage I amplifier section 102 includes an amplifier 206, such as a transconductance amplifier. An output of the amplifier 206 is coupled to the stage II buffer section 104. In this exemplary implementation, the buffer section 104 includes a resistor 208 coupled to a transistor 210. The transistor 210 is shown as a PMOS transistor, where the source of the transistor 210 is coupled to an end of the resistor 208, the drain of the transistor 210 is connected to ground and the gate is coupled to the output of the amplifier 206. As those skilled in the art appreciate, the stage II buffer section 104, as illustrated in FIG. 2, is a source follower configuration.

The low impedance section 110 is coupled to the output of the amplifier 206, and is further coupled to the gate of the transistor 210. In the embodiment illustrated in FIG. 2, the low impedance section 110 includes the resistor 202, where one end of the resistor 202 is coupled to ground and another end is coupled to the stages 102 and 104. In one implementation, the resistor 202 is a poly-resistor. As those of skill in the art appreciate, the positioning of the low impedance section 110 creates a low impedance level at node A.

The stage II amplifier section 106 illustrated in FIG. 2 may be a PMOS transistor 212, such as a driver transistor or any other high current device. In one implementation, the PMOS transistor 212 has a gate connected to the source of the PMOS transistor 210 and a drain connected to the capacitor 204. The drain of the transistor 212 is also connected to the output section 108. In the FIG. 2, the output section 108 may include a load current 214 in parallel with a load resistor 216.

The impedance section 110 is in parallel with a number of the transistors that implement the amplifier 206. The impedance section 110 has a resistance that is lower than the resistances associated a number of the transistors of the amplifier 206, which creates the low impedance level at node A.

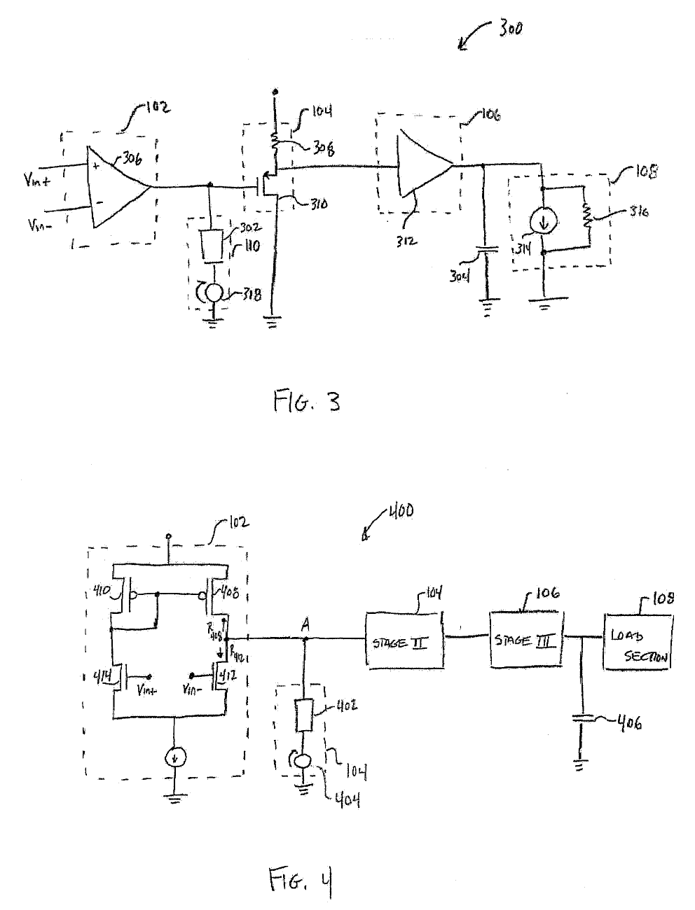

FIG. 3 illustrates a schematic circuit diagram of an LDO circuit arrangement 300 according to at least one exemplary implementation. The low impedance section 110, implemented in this illustration with a resistor 302 and a biasing source 318, enables use of a substantially small capacitor 304 in an output stage of the LDO circuit arrangement 300.

In the implementation illustrated in FIG. 3, the stage I amplifier section 102 includes an amplifier 306, such as a transconductance amplifier. An output of the amplifier 306 is coupled to the stage II buffer section 104. In this exemplary implementation, the buffer section 104 includes a resistor 308 coupled to a transistor 310. The transistor 310 is shown as a PMOS transistor, where the source of the transistor 310 is coupled to an end of the resistor 308, the drain of the transistor 310 is connected to ground and the gate is coupled to the output of the amplifier 306. As those in the art appreciate, the stage II buffer section 104, as illustrated in FIG. 3, is a source follower configuration.

The low impedance section 110 is coupled to the output of the amplifier 306, and is further coupled to the gate of the transistor 310. In the embodiment illustrated in FIG. 3, the low impedance section 110 includes the resistor 302, where one end of the resistor 302 is coupled to the biasing source 318 and another end is coupled to the stages 102 and 104. In one implementation, the resistor 302 is a poly-resistor and the biasing source 318 is circuitry that tracks the DC voltage of node A and biases the resistor to a DC voltage detected at node A. As those of skill in the art appreciate, the positioning of the low impedance section 110 creates a low impedance level at node A.

The stage II amplifier section 106 illustrated in FIG. 3 may be a PMOS transistor 312, such as a driver transistor or any other high current device. In one implementation, the PMOS transistor 312 has a gate connected to the source of the PMOS transistor 310 and a drain connected to the capacitor 304. The drain of the transistor 312 is also connected to the output section 108. In the FIG. 3, the output section 108 may include a load current 314 in parallel with a load resistor 316.

The impedance section 110 is in parallel with a number of the transistors that implement the amplifier 306. The impedance section 110 has a resistance that is lower than the resistances associated a number of the transistors of the amplifier 306, which creates the low impedance level at node A.

FIG. 4 illustrates a detailed schematic circuit diagram of an LDO circuit arrangement 400 employing a low impedance section 104 to improve stability, when good noise performance is desirable. The low impedance section 104, implemented in this illustration with a resistor 402 and a biasing source 404, enables use of a substantially small capacitor 406 in an output stage of the LDO circuit arrangement 400. The arrangement 400 may also be implemented without the use of the biasing source 404 as part of the low impedance section 104.

In FIG. 4, additional details of the stage I amplifier section 102 are shown to further illustrate how the use of the low impedance section 104 creates a low impedance point at node A. As is illustrated, the stage I amplifier section 102 may include PMOS transistors 408 and 410, and NPN transistors 412 and 414. The output resistance of the transistor 408 is R₄₀₈ and the output resistance of the transistor 412 is R₄₁₂. The impedance at node A is R₄₀₈, R₄₁₂, and the resistance of the resistor 402 in parallel. The resistance of the resistor 402 is smaller than the resistances R₄₀₈ and R₄₁₂, so the impedance at node A substantially equals the resistance of resistor 402. This establishes a low impedance point a node A.

The low impedance point at node A allows the freedom to select a substantially small capacitor for use as an output capacitor 406. As was discussed earlier herein, an optional biasing source 404 may be used to bias the resistor 402 to a voltage detected at node A. Use of the biasing source 404 may substantially avoid asymmetry conditions at an operating point of the stage I amplifier section 102.

Without the low impedance section 104, which is the case in conventional LDO circuit arrangements, the resistances R₄₀₈ and R₄₁₂ would dominate the effective resistance associated with the stage II buffer section 104. This does not allow the freedom to select a substantially small bypass capacitor at the output of a final amplifier stage of a conventional LDO circuit arrangement.

The technology shown in FIGS. 1-4 is merely illustrative of a select few components that may be used to design an LDO circuit arrangement. Those of ordinary skill in the art appreciate many other component combinations may be used to develop the devices illustrated in the figures.

### Conclusion

For the purposes of this disclosure and the claims that follow, the terms “coupled” and “connected” have been used to describe how various elements interface. Such described interfacing of various elements may be either direct or indirect. Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

What is claimed is:

1. A circuit, comprising:
an amplifier arrangement to provide a substantially constant voltage; and
a low impedance section coupled to the amplifier arrangement, the low impedance section having a resistance to influence an impedance of the amplifier arrangement.

2. The circuit according to claim 1, wherein the low impedance section includes a resistor.

3. The circuit according to claim 1, wherein the low impedance section includes a ploy-resistor.

4. The circuit according to claim 1, wherein the low impedance section includes a resistor in series with a biasing source.

5. The circuit according to claim 1, wherein the low impedance section includes a poly-resistor in series with a biasing source.

6. The circuit according to claim 1, wherein the amplifier arrangement includes a first stage amplifier section coupled to a buffer section, the low impedance section having a first end coupled to an output of the first stage amplifier section.

7. The circuit according to claim 6, wherein the low impedance section includes a resistor connected to ground.

8. The circuit according to claim 6, wherein the low impedance section includes a resistor coupled to a biasing source, the resistor having a first end coupled to the first stage amplifier section and the buffer section and a second end coupled to the biasing source.

9. The circuit according to claim 1, wherein the amplifier arrangement includes a transconductance amplifier coupled to a buffer section, the buffer section coupled to a driver transistor, the amplifier arrangement further including a capacitor coupled to an output of the driver transistor.

10. The circuit according to claim 9, wherein the low impedance section is coupled to an output of the transconductance amplifier, the low impedance section including a resistor coupled to ground.

11. The circuit according to claim 9, wherein the low impedance section is coupled to an output of the transconductance amplifier, the low impedance section including a resistor and a biasing source having a first end coupled to the resistor and a second end coupled to ground.

12. The circuit according to claim 9, wherein the low impedance section is coupled to an output of the transconductance amplifier, the low impedance section including a poly-resistor and a biasing source having a first end coupled to the poly-resistor and a second end coupled to ground.

13. A voltage regulator circuit, comprising:
a multistage amplifier arrangement to provide a voltage output; and
a low impedance section coupled to a first stage of the multistage amplifier arrangement, the low impedance section having a resistance to influence an impedance of the multistage amplifier arrangement.

14. The voltage regulator circuit according to claim 13, wherein the low impedance section includes a resistor.

15. The voltage regulator circuit according to claim 13, wherein the low impedance section includes a ploy-resistor.

16. The voltage regulator circuit according to claim 13, wherein the low impedance section includes a resistor in series with a biasing source, the biasing source being coupled to ground.

17. The voltage regulator circuit according to claim 13, wherein the low impedance section includes a poly-resistor in series with a biasing source.

18. The voltage regulator circuit according to claim 13, wherein the multistage amplifier arrangement includes a first stage amplifier section coupled to a buffer section, the low impedance section having an end coupled to an output of the first stage amplifier section.

19. The voltage regulator circuit according to claim 18, wherein the low impedance section includes a resistor connected to ground.

20. The voltage regulator circuit according to claim 18, wherein the low impedance includes a resistor coupled to a biasing source, the resistor having a first end coupled to the first stage amplifier section and the buffer section and a second end coupled to the biasing source.
